(19) United States
(12) Patent Application Publication
(10) Pub. No.: US 2002/0134811 A1
(43) Pub. Date: Sep. 26, 2002

(54) Multi-mode power tool utilizing attachment

(75) Inventors: John Napier, Maineville, OH (US); Shane Adams, Kettering, OH (US)

Correspondence Address: David E. Franklin, Wood, Herron & Evans, L.L.P., 2700 Carew Tower, 441 Vine Street, Cincinnati, OH, 45202-2917, US

(73) Assignee: Senco Products, Inc.

(21) Appl. No.: 09/771,823

(22) Filed: Jan. 29, 2001

(51) Int. Cl. B27F 1/02

(52) U.S. Cl. 227/131; 227/134

(57) ABSTRACT

A power tool includes multiple attachments to selectively perform rotary motions, reciprocating motions, and multiple impact motions upon a work surface. For example, tool attachments may be selected to configure the power tool as a nailer, stapler, biscuit jointer, drill, hammer drill, detail sander, sheet metal nibbler, router, buffer, jig saw, chipping tool, saws all, as well as other types of power tools. A base unit provides a rotary input that is adapted to each engaged tool attachment. In particular, a power tool control system in the base unit senses an attachment type designation from the tool attachment, as well as user inputs and motor feedback, to change motor control. Examples of these adaptions include changing motor speed, changing trigger operation from on/off to variable speed, responding to or ignoring a forward/reverse control, as well as monitoring motor feedback and sensors in the tool attachment for conditions warranting motor deactivation.

### BACKGROUND OF THE INVENTION

I. Field of the Invention

The invention relates to power tools, and more particularly, to portable hand tools that selectively perform linear reciprocating, rotary and multiple impact motions on a work piece.

II. Description of Prior Art

Users rely upon power tools to perform a large number of tasks in do-it-yourself home maintenance as well as in industries such as manufacturing, construction and repair services. Not only is productivity increased over the use of manual tools, in some instances power tools are indispensable.

Traditionally, each power tool performs only a specific task or related class of tasks. Examples of these specialized power tools include drills, sanders, saws, and many others. While each power tool could appropriately perform the specialized task, purchasing a wide array of specialized power tools is expensive. For another example, storing and transporting a large number of specialized power tools to a work site is often inconvenient.

Power tools with attachments have addressed this inefficiency to an extent. A part of the power tool containing a motor and controls is used with various attachments. Generally, however, these attachments are limited to converting the rotary motion of the motor into another rotary or a reciprocating motion on a workpiece. Furthermore, the controls of power tools with attachments generally are not altered by the type of attachment. Consequently, mechanical safety features are necessary to prevent movement of dangerous attachments when the trigger is inadvertently depressed. Also, the user is required to monitor the power tool for binding and proper motor speed. Consequently, a significant need exists for an improved power tool with multiple attachments that more efficiently performs a wide range of tasks.

Power tools generally consume a large amount of power, provided by an external source of electrical power, pneumatic power, or hydraulic power. In many cases, this power is obtained from electrical utility sources using wall outlets or other connections. Often, however, a source of external power is not available or is inconvenient to provide. For example, a work site may not have nearby wall outlets for electrical power and the user may not have a portable electrical generator.

One example of a power tool is an automatic fastener driver, such as a stapler or a nailer. Some nailers use pyrotechnic cartridges (e.g., 0.22 cartridges) as a substitute for external sources of power. These cartridges have sufficient power to drive in a fastener, but are an expensive substitute. Although advances in battery and efficient electrical motor technology have occurred, nailers have peak power demands that have thus far limited the use of battery power. In general, large momentary power demands degrade battery performance and service life. Batteries have an internal impedance that dissipates a large amount of energy as heat when high current demands occur.

Given these difficulties with known approaches for driving in the fastener with battery power, efforts have been made to develop a powered fastener tool that aids inserting fasteners by vibrating the fastener. Specifically, in these tools, a user has to manually force the fastener into position, assisted by the vibration. Notably, however, a vibrating fastener tool provides very little assistance to the user.

The peak power demands of fastener drivers are successfully addressed with multiple impact fastener driving tools. For example, U.S. Pat. No. 5,927,585 to Moorman et al., which is incorporated herein by reference in its entirety, effectively lowered this peak power demand by successively impacting the fastener. In particular, a motor driven cam wheel with a single drop-off lifted a reciprocal hammer via a cam follower roller against a compression spring. Each time the cam follower roller encountered the single drop-off of the cam wheel, the hammer assembly was allowed to fall, actuated by the compression spring. This action provided the impetus to drive the fastener without significant manual pressure from the user. The Moorman multiple impact fastener driving tool is thus a significant advancement in portable power tool technology. However, it, like other power tools, is a special purpose device not suited for other tasks, and so does not avoid the need to own, store, and transport a large number of other specialized tools.

### SUMMARY OF THE INVENTION

The present invention addresses these and other problems in the prior art by providing a power tool for use with an attachment that is responsive to the type of engaged tool attachment by appropriately altering operation of a motor. Thus, appropriate safety and operational features are provided automatically without requiring a user to perform additional steps, such as actuating mechanical safety locks.

In one aspect consistent with the invention, a device includes a base unit selectively engaged to and providing a rotary input from a motor to a tool attachment. The device includes a motor controller that responds to a user input and to an attachment type designator of the tool attachment to selectively activate the motor.

In another aspect consistent with the invention, a power tool includes a base unit selectively engaged to and providing a rotary input from a variable speed motor to a tool attachment. The tool attachment is configured to convert the rotary input from the base unit into a predetermined one of a linearly reciprocating motion, rotary motion, and multiple impact motion. A motor controller of the base unit is responsive to a user input, a motor speed sensor, and an attachment type designator of the tool attachment to selectively activate the motor from power provided by a portable power supply.

These and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a schematic diagram of a power tool in accordance with the principles of the present invention;

FIG. 2 is a flow chart of a sequence of operations performed by the controller of the power tool of FIG. 1.

FIG. 3 is a partial cross sectional view, with the housing in phantom, of a power tool of FIG. 1 configured with a stapler attachment and illustrating a locking alignment mechanism.

FIG. 4 is a perspective view of a multiple impact mechanical drive train for the stapler attachment of FIG. 3.

FIG. 5 is a cross sectional view of locking alignment mechanism of FIG. 3, taken generally along lines 5-5.

FIG. 6 is a cross sectional view of the locking alignment mechanism of FIG. 5, taken generally along lines 6-6.

FIG. 7 is an elevational view, with the housing in phantom, of the power tool of FIG. 3 configured with a sheet metal nibbler attachment.

FIG. 8 is a cross sectional view of the vertically reciprocating drive train of the power tool of FIG. 7, taken generally along lines 8-8.

FIG. 9 is a partial cross sectional view, with the housing in phantom, of the power tool of FIG. 3 configured with a horizontally reciprocating detail sander attachment.

FIG. 10 is a cross sectional view of the power tool of FIG. 9 taken generally along lines 10-10.

FIG. 11 is an elevational view, with the housing in phantom, of the power tool of FIG. 3 configured with a biscuit jointer attachment.

FIGS. 12A-12C are cross sectional views of an illustrative attachment interface of the power tool of FIG. 3.

### DETAILED DESCRIPTION OF THE DRAWINGS

Introduction

For purposes of this description, words such as “vertical”, “horizontal”, “right”, “left” and the like are applied in conjunction with the orientation of the tools shown in the drawings for purposes of clarity. As is well known, power tools may be oriented in substantially any orientation, so these directional words should not be used to imply any particular absolute directions for a power tool consistent with the invention.

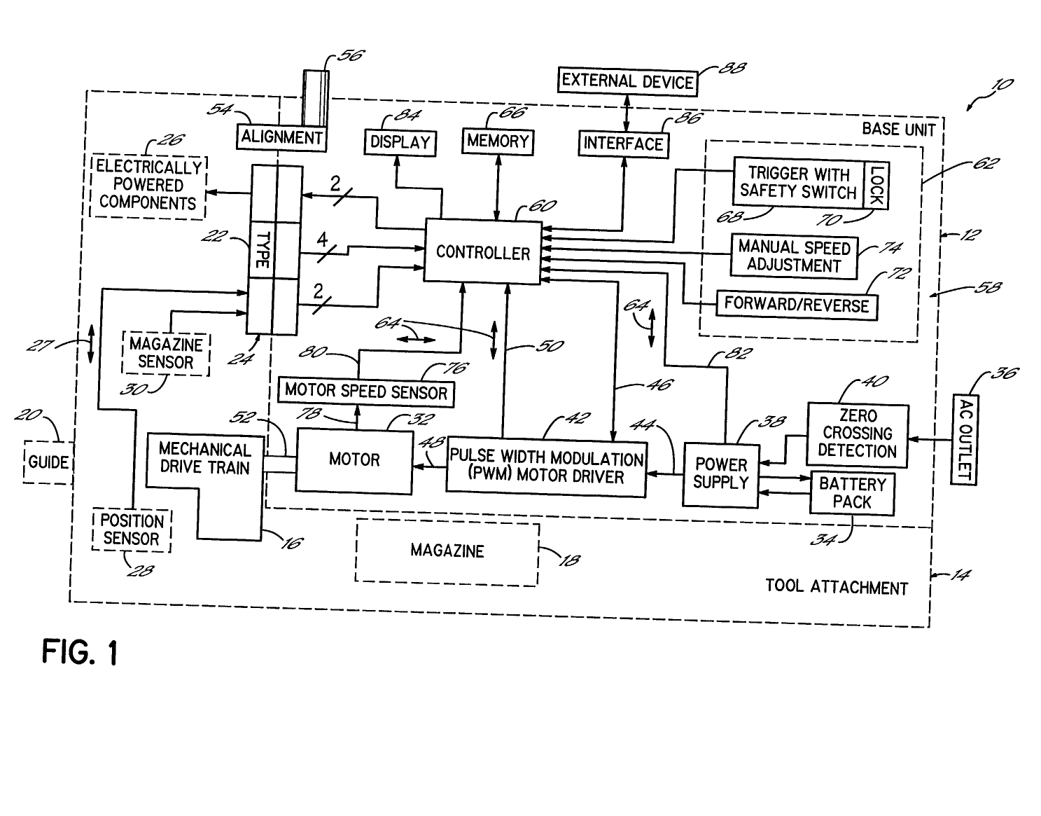

With reference to FIG. 1, there is shown a power tool 10 comprised of a base unit 12 selectively engaged to a tool attachment 14. Different types of tool attachments 14 are selectable, each with an appropriate mechanical drive train 16 that selectively converts a rotary input from the base unit 12 to a predetermined one of a multiple impact motion, rotary motion, or reciprocating motion.

The multiple impact motion type of tool attachment 14 includes fastener driving tools, such as nailers and staplers, that may include a fastener magazine 18. For other types of tool attachment 14, the mechanical drive train 16 may include a replaceable cutting or abrasion device (not shown in FIG. 1), Various types may also include either a fixed or removable guide 20 for positioning the tool attachment 14 with respect to a work surface (not shown). Examples of various types of tool attachments 14 are included below in Table 1.

In particular, the various types of tool attachment 14 are identified on the tool attachment 14 via an attachment type designator 22 present at an attachment interface 24. For example, a 4-digit binary code enabling 16 different attachment type designations 22 may be provided by a pattern of bumps or tabs on the tool attachment 14 that are read by corresponding micro-switches (not shown) on the base unit 12. As another example, the attachment interface 24 may comprise an electrical connector (not shown) wherein open, shorted, or omitted pins designate a particular attachment type. As a third alternative, the attachment type and other parameters may be designated in an electrically readable memory device in attachment 14, connected electrically or through radio frequency or magnetic induction to base unit 12 so that the designations can be electrically read.

In addition, such an electrical connector or additional connectors at the attachment interface 24 between the tool attachment 14 and base unit 12 advantageously includes electrical connections for optional electrically powered components 26 in attachment 14, as well as circuitry for providing attachment feedback sensors 27, depicted as a position sensor 28 and a magazine sensor 30, discussed below in connection with fastener applications. It should be appreciated that optical communication between the attachment 14 and base unit 12 may be used in addition to, or as an alternative for, the attachment type designations 22 and electrical excitation to powered components 26 and feedback sensors 27.

Table 1 illustrates one coding scheme that could be used in designator 22 for various types of attachments. The use of each attachment identified in Table 1 will be explained hereafter.

TABLE 1

| ATTACHMENT TYPE | CODE | ATTACHMENT MOTION | MAG. | TRIGGER | POS'N | ADDITIONAL |
|---|---|---|---|---|---|---|
| NO ATTACHMENT | 0000 | N/A | | VARIABLE | N/A | |
| NAILER | 0001 | MULTIPLE IMPACT | YES | FIXED | YES | |
| STAPLER | 0010 | MULTIPLE IMPACT | YES | FIXED | YES | |
| BISCUIT JOINTER | 0011 | ROTARY | | VARIABLE | | |
| DRILL | 0100 | ROTARY | | VARIABLE | | REVERSIBLE |
| HAMMER DRILL | 0101 | ROTARY | | VARIABLE | | REVERSIBLE |
| DETAIL SANDER | 0110 | HORIZONTAL RECIPROCATING | | FIXED | | |
| SHEET METAL NIBBLER | 0111 | VERTICAL RECIPROCATING | | VARIABLE | | FOOT GUIDE |
| ROUTER | 1000 | ROTARY | | VARIABLE | | FOOT GUIDE |
| BUFFER | 1001 | ROTARY | | VARIABLE | | |
| JIG SAW | 1010 | VERTICAL RECIPROCATING | | VARIABLE | | FOOT GUIDE |
| CHIPPING TOOL | 1011 | MULTIPLE IMPACT | | VARIABLE | | |
| SAWS ALL | 1100 | VERTICAL RECIPROCATING | | VARIABLE | | FOOT GUIDE |
| OPEN | 1101 | | | | | |

The rotary input from the base unit 12 is provided by a motor 32. In the illustrative version, the motor 32 is a pulse width modulated (PWM) DC motor, although other types of motors may be used consistent with the invention. The PWM motor 32 readily allows for controllably changing motor speed.

Electrical power for the motor 32 is advantageously available from two sources: a battery pack 34 and an external electrical power source, such as an AC wall outlet 36. A power supply 38 switches between the sources 34, 36, assisted by a zero cross detection circuit 40 that detects whether an appropriate external AC electrical source is available. The power supply 38 regulates power from either of the sources 34, 36 to provide one or more voltage levels appropriate for the various components of the base unit 12.

The power supply 38 is depicted as recharging the battery pack 34 when the base unit 12 is plugged into an AC outlet 36. It should be appreciated that applications consistent with the invention may rely only on a battery pack 34 or only on an AC outlet 36. Moreover, the battery pack 34 may be non-rechargeable or recharged by an external device (not shown).

The power supply 38 powers a PWM motor driver 42 via power connection 44. The motor driver 42 responds to a motor command signal over line 46 by providing an appropriate motor current to a power connection 48. The motor driver 42 also provides a motor current signal over line 50 that indicates the current being supplied to motor 32 when it has been activated.

The PWM motor driver 42 may advantageously include current limiting that provides a soft motor start, extending the service life of the motor 32 and battery pack 34.

The rotary input produced by the motor 32 is transferred to the mechanical drive train 16 of the tool attachment 14 by a coupling 52. For example, a coupling 52 is in the form of a splined drive shaft that slidingly engages a geared member (not shown in FIG. 1) of the mechanical drive train 16.

The proper alignment and selective retention of the coupling 52 with the mechanical drive train 16 is assisted by an alignment member 54 having portions attached to each of the base unit 12 and tool attachment 14. The alignment member 54 has a disengagement member 56 responsive to a user's input to selectively engage and disengage the alignment member 54.

Power tool control system

A power tool control system 58 adapts performance of the motor 32 to the type of tool attachment 14 engaged to the base unit 12. In particular, the power tool control system 58 has a motor controller 60 in the base unit 12 that is responsive to a user input 62, the attachment type designator 22, and motor feedback on lines 64, discussed below, to selectively activate the motor 32.

The motor controller 60 performs computation and control functions of the power tool control system 58, and comprises a suitable central processing unit (CPU). Such a processor may comprise a single integrated circuit, such as a microprocessor, or may comprise any suitable number of integrated circuit devices and/or circuit boards working in cooperation to accomplish the functions of a processor. Processor suitably executes a computer program within a memory 66.

User input 62 in the illustrative embodiment of FIG. 1 includes a trigger 68 that has a redundant safety switch signal for detection of switch failures. A trigger lock 70 may be actuated with the trigger 68 depressed to maintain the trigger 68 in the depressed state. The trigger lock 70 may comprise an electronic or electronically held switch that may be overridden by the controller 60 for certain types of tool attachment 14.

The user input 62 further includes a forward/reverse switch 72 that enables a user input 62 to reverse direction of the rotary input from the motor 32 for certain types of tool attachment 14. In addition, a manual speed adjustment control 74 enables a user to alter default speed settings for a given tool attachment 14. For example, a user may desire to reduce the rotary input from the motor 32 to extend battery life or to reduce heating of a cutting tool bit.

The motor feedback 64 is illustrated in FIG. 1 as including a motor speed sensor 76 that senses a motor parameter 78 of the motor 32 indicative of motor speed. The motor speed sensor 76 converts the motor parameter 78 into a motor speed signal 80 and transmits the motor speed signal 80 to the controller 60.

The motor feedback 64 may further include or alternatively comprise the motor current signal on line 50 and/or a power source indication on a line 82 from the power supply 38, indicating whether AC or battery power is being used.

The controller 60 advantageously enables additional features. For example, a display 84, such as a liquid crystal display (LCD), controlled by the controller 60, displays information for the user, such as type of tool attachment 14 based on attachment type designator 22. The display may also indicate remaining service life of the battery pack 34, diagnostic information, service time expended or remaining on the tool attachment 14 and motor 32, remaining number and type of fasteners in magazine 18, current user selectable settings, etc.

The display 84 may further include input capabilities, such as a touch screen, allowing input of security codes to enable activation of the device, menu options to change system defaults, or to manually enter the type of tool attachment 14. The latter capability may be helpful when the attachment type designator 22 is damaged or for other reasons.

The memory 66, accessed by the controller 60, stores data for these purposes as well as others. In particular, at least a portion of the memory 66 is beneficially nonvolatile and rewriteable for the purpose of storing updated data and computer programming. For example, the computer program performed by the controller 60 may be upgradeable via an interface 86 (e.g., RS-232 interface, USB connector, infrared port) to an external device 88. Upgrades would allow for additional customized operation to be made available for new tool attachments 14 or to change operation for existing tool attachments 14.

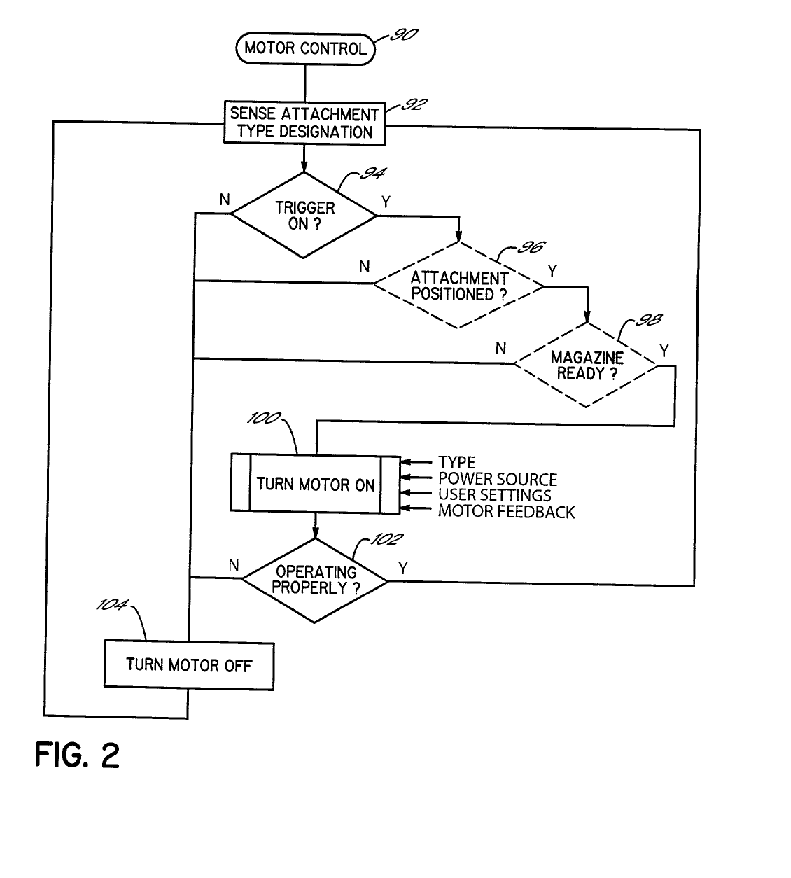

Referring to FIG. 2, an illustrative motor control sequence of operations 90 is performed by the power tool control system 58 to respond to the tool type designator 22, user input 62, and motor feedback 64.

Beginning in block 92, the attachment type designation is sensed. Then a determination is made in block 94 as to whether the trigger is depressed (ON). This determination advantageously includes safety checks for a broken trigger in order to reduce the likelihood of inadvertent activation. The trigger ON determination may further include waiting for the trigger to remain ON for a predetermined period of time for ignoring spurious commands.

Further, the trigger ON determination may also include a time-out that limits valid trigger signals to a specific duration. This feature would prevent inadvertent battery drain due to the power tool 10 left on with the trigger 68 inadvertently depressed or locked.

If in block 94 the trigger is on, then a determination may be made in block 96 as to whether a position sensor indicates that the tool attachment is correctly positioned. This determination is performed when the attachment type designation in block 92 indicated that such a safety check is available and appropriate. For example, fastener drivers like nailers and staplers are less likely to inadvertently activate if a check is made that the position sensor is activated before the trigger.

If the attachment is positioned in block 96, then a determination is made in block 98 as to whether the magazine is ready. Again, this determination depends on whether the sensed attachment type designation in block 92 indicates that this check is available and appropriate. Battery life may be extended if tool activation is prevented when the magazine is empty or detached.

If the magazine is ready in block 98, then in block 100 the motor 32 is turned on in a manner appropriate to various conditions. For example, as illustrated in Table 1, the type of tool attachment 14 may determine whether the trigger responds with an on/off signal for motor control at a fixed speed or responds with a variable speed depending on the trigger 68 and/or manual speed adjustment 74.

Turning the motor 32 on in block 100 may advantageously depend at least in part upon the source of power. Thus, activation may be prevented if the power source indication on line 82 indicates that insufficient battery power remains. Alternatively or additionally, the motor speed may be increased if power from an AC outlet 36 is sensed by the zero crossing detection circuit 40.

Once the motor 32 is on in block 100, then a determination is made in block 102 as to whether the power tool 10 is operating properly. In particular, a determination is made based on motor feedback 64 that the motor 32 should remain running. For example, a fault condition of a motor stall, or a motor stall for a period of time, may warrant disabling the motor 32 until the trigger block 94 is recycled. As another example, alternative or additional fault conditions may be tested for motor over-speed, exhausted service life, over-temperature of a component such as the motor 32 or battery pack 34, or detected failure in the power tool control system 58.

If operating properly in block 102, then motor control iterates back to block 92 to continue operation. However, if block 102 a fault is detected, then the motor 32 is turned off in block 104. The other precursor conditions for motor operation in blocks 94-98 would also proceed to block 104, preventing motor operation, if one of the conditions was not met. Then, motor control returns to block 92.

Allowing a restart of the motor 32 after the motor 32 is turned off in block 104 may further include an additional step by the user, such as cycling the trigger 68 or the absence of the condition that resulted in a fault being detected.

The adaptability of the power tool control system 58 to various types of tool attachments 14 is illustrated by examples of various mechanical drive trains 16 and other alterations in motor control specific to these types.

Multiple impact tool attachment

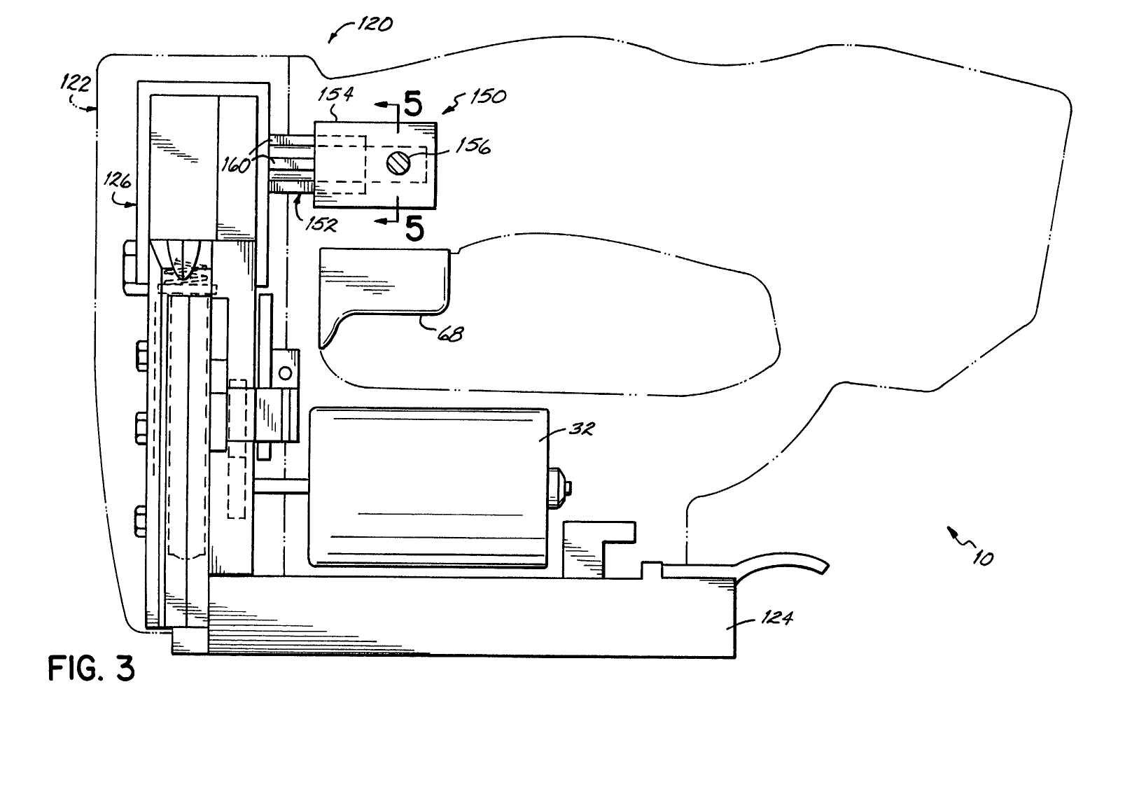

With reference to FIG. 3, a power tool 10 is configured as a stapler 120 by engaging a stapler tool attachment 122 having a staple magazine 124 and a multiple impact drive train 126. As discussed in the previously referenced U.S. Pat. No. 5,927,585, the multiple impact drive train 126 hammers in each staple from the staple magazine 124.

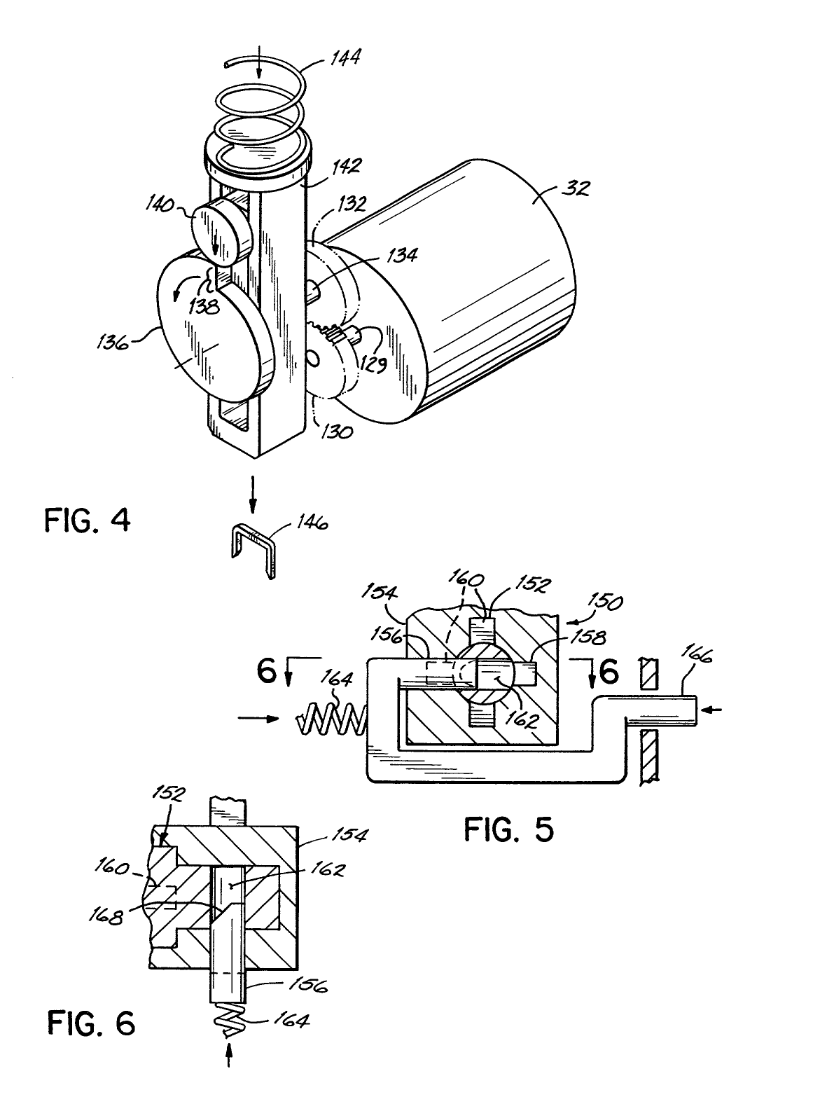

With reference to FIG. 4, the multiple impact drive train 126 is depicted wherein the motor 32 has a coupling 52, in particular a drive shaft 129, that drives a first gear 130 in the stapler tool attachment 122, which in turns drives a meshed, second gear 132. The second gear 132 is axially coupled via shaft 134 to a cam wheel 136 having a single drop-off 138. A cam follower roller 140 is laterally constrained within a hammer assembly 142 and is in circumferential contact with the cam wheel 136.

As the cam wheel 136 rotates, the cam follower 140 is raised by the increased encountered radius of the cam wheel 136. The cam follower 140 transfers this upward motion to the hammer assembly 142, compressing a compression spring 144. When the cam follower 140 encounters the drop-off 138, the cam follower 140 and hammer assembly 142 rapidly fall, transferring the power stored in compression spring 144 during a previous full rotation of the cam wheel 136 to a staple 146.

A multiple impact drive train 122 may be readily tailored to other types of tool attachments 14, such as a nailer or a stapler 120 for a different size staple. In particular, the relative ratios of gears 130, 132 may be determined for the desirable rate of impacts (i.e., rotation rate of the cam wheel 136). The height of the drop-off 138 may be configured for the compression spring 144 and the height of the fastener, etc.

Returning to FIG. 3, the stapler 120 also includes an alignment and locking mechanism 150. In particular, a splined shaft 152 attached to the stapler tool attachment 122 is received within a receptacle 154 in the base unit 12. A locking pin 156 in the base unit 12 holds the splined shaft 152 into full engagement within the receptacle 154 until released by the user.

With reference to FIG. 5, the receptacle 154 is depicted as having grooves 158 that guide splines 160 on the splined shaft 152 into an orientation for the locking pin 156 to enter a locking pin hole 162 in the splined shaft 152. The locking pin 156 remains engaged by the force from a spring 164 until overcome by a user-actuated member 166.

With reference to FIG. 6, the locking pin 156 is depicted as having a forward facing beveled surface 168 to allow automatic engagement of the locking pin 156 when the tool attachment 122 is pushed into contact with the base unit 12.

It should be appreciated that various numbers of alignment and locking mechanisms 150 may be incorporated into the power tool 10. Moreover, the user actuated portions of the alignment and locking mechanism 150 may be on the tool attachment 122 rather than on the base unit 12. Further, rather than manually actuated locking methods, electromechanical mechanisms may be employed.

With reference to FIGS. 1-3, the power tool control system 58, in response to sensing the stapler attachment 122, alters motor operation. The trigger 68 becomes an on/off user input rather than a variable motor speed user input. The reverse/forward switch 72, if present, is ignored.

Further operational changes may be included. For example, a depression of the trigger 68 is required after sensing that the position sensor 28 is activated and the magazine sensor 30 is ready. As another example, depending on a size of sensed staple, the multiple impact drive train 126 may perform a predetermined number of hits on any given staple during the depression of the trigger 68.

Alternatively, the multiple impact drive train 54 may continue impacting a staple until the position sensor 28 indicates that the staple is fully positioned into the work surface. For example, a fastener is used to tack down a communication wire. The position sensor 28 ensures that the fastener is sufficiently positioned to contact the communication wire, but also shuts off the motor 32 before the fastener damages the communication wire.

As yet a further example, the motor speed is advantageously adjusted for user preference and user technique. Different users apply different amounts of force on the power tool 10 to the work surface. Changing the rate of multiple impacts per the manual speed adjustment 74, or automatically based on another sensor input, would adjust the sound of the power tool 10 and optimize fastener placement.

Reciprocating tool attachments

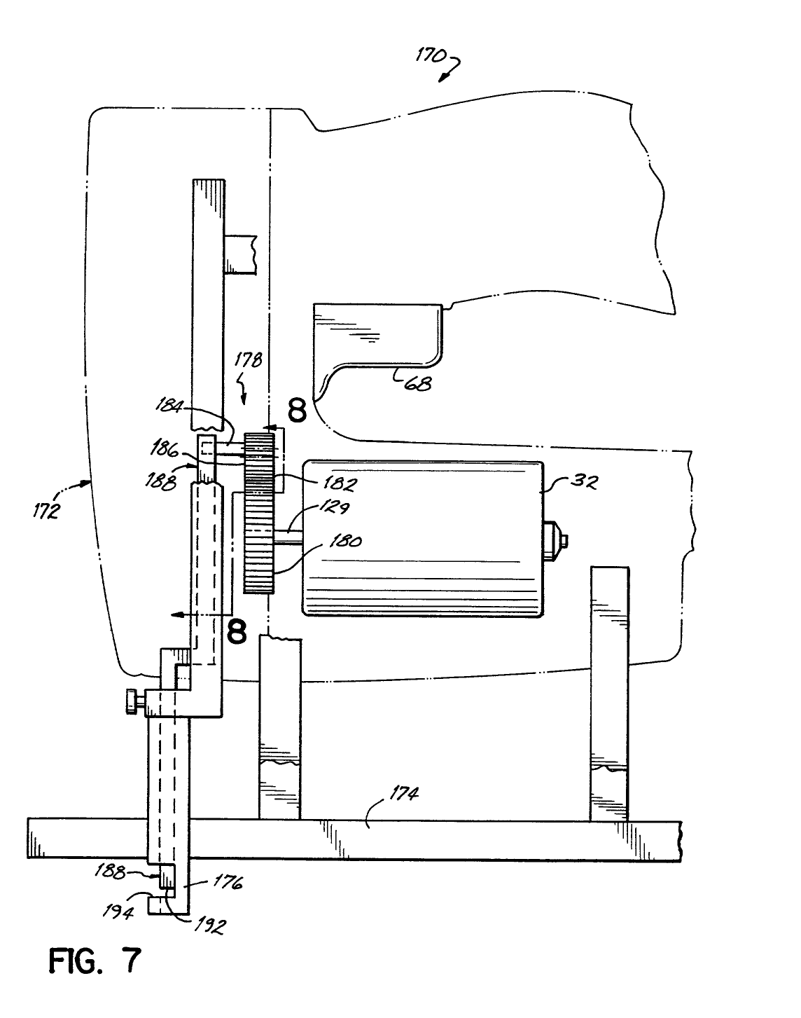

With reference to FIG. 7, a power tool 10 is configured as a sheet metal nibbler 170 by engaging a sheet metal nibbler tool attachment 172 to the base unit 12. A fixed or removable guide 20, or foot 174, positions a punch housing 176 with respect to a work surface (not shown).

With reference to FIGS. 7 and 8, the tool attachment 172 includes a mechanical drive train 178 for producing a vertically-oriented linearly reciprocating motion. The motor 32 couples via the drive shaft 129 to a first gear 180 that is meshed with a second gear 182 having pin 184 attached to a forward face 186 of gear 182. This pin 184 acts as a cam to change the rotary motion of the second gear 182 into a vertically reciprocating motion of a punch 188 that moves within the punch housing 176.

With particular reference to FIG. 8, the pin 184 slides within a lateral slot 190 in the punch 188. Thus, as the second gear 182 rotates, the punch 188 follows the vertical movement of the pin 184. A cutting edge 192 of the punch 188 is exposed by a forward opening 194 in the punch housing 176 for imparting the vertical motion to the material to be cut.

It should be appreciated that the foot 174 may be selectively removed for freehand operations and to be adjustable in orientation for use with other types of tool attachments 14. For example, the foot 174 may have a sliding scale and foot locking member (not shown) that allow for right and left angular adjustments for beveled cuts. Ensuring that the foot 174 has the proper orientation with respect to the tool attachment 14 and base unit 12 may be ensured with a similar alignment and locking mechanism 150.

It should be further appreciated that relative size of gears 180, 182 and position of the pin 184 upon the face 186 of the second gear 182 may selectively choose the speed and vertical travel of the punch 188. Moreover, similar selections will adapt the vertically reciprocating mechanical drive train 178 to other types of tool attachments 14.

For example, a jig saw tool attachment (not shown) would entail a cutting edge 192 in the form of a replaceable, forward facing, straight saw blade. The vertically reciprocating mechanical drive train 178 would generally be adapted to provide a greater vertical travel distance at a slower rate.

Similarly, a sawsall tool attachment (not shown) would entail a cutting edge 192 in the form of a replaceable, rearward facing, straight saw blade. A smaller foot 174 is typically included. Alternatively, a chipping tool attachment (not shown) would use the same foot 174 as the sheet metal nibbler tool attachment 172 and would employ a replaceable chipping tool that is exposed below a housing.

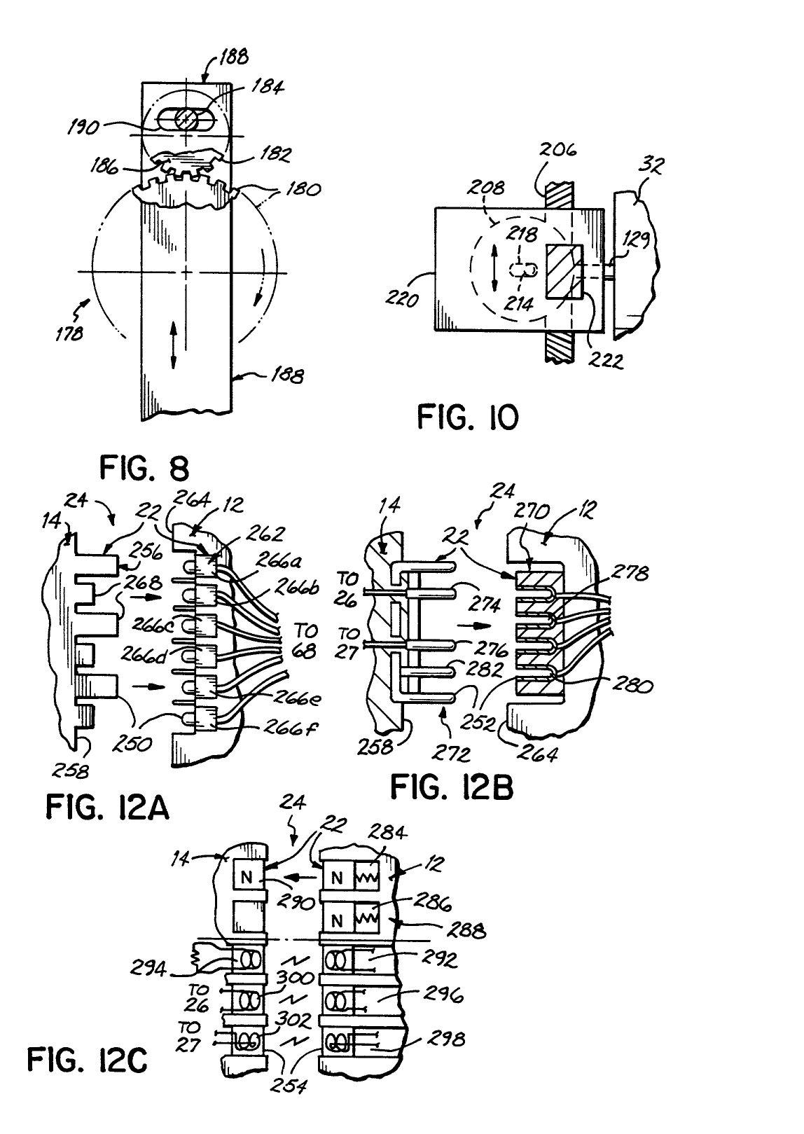

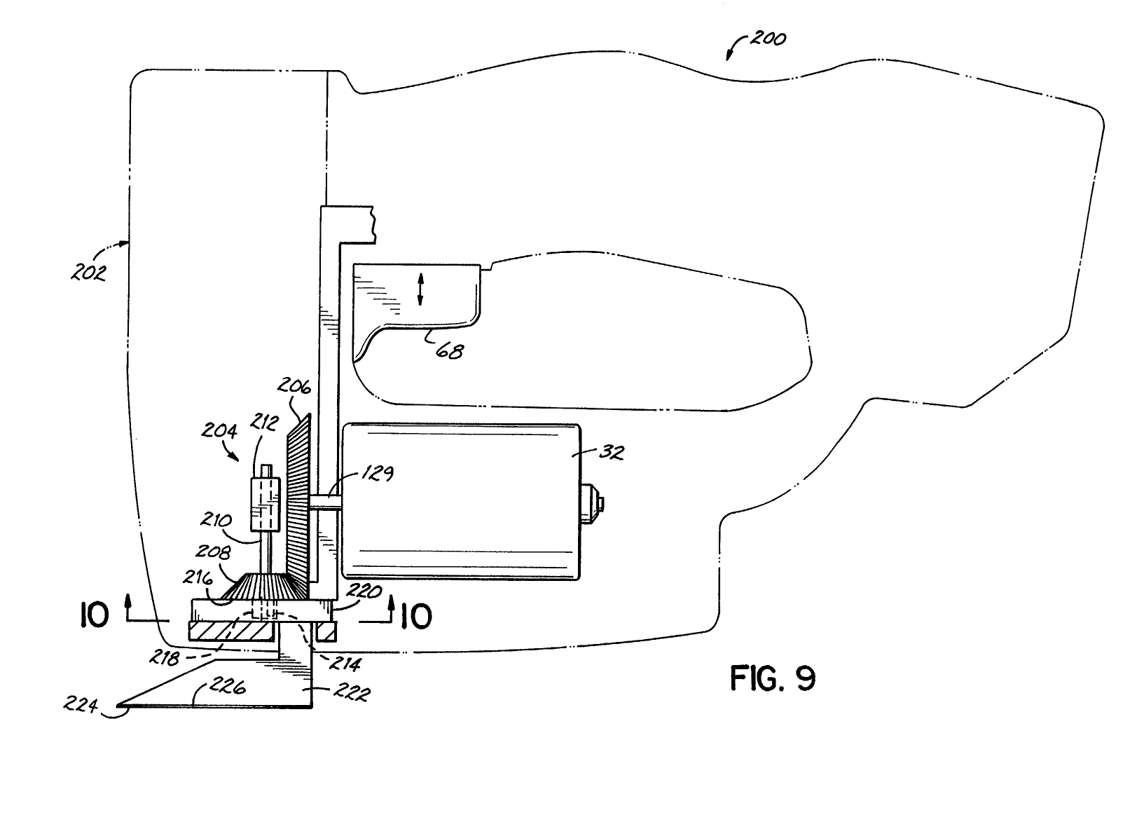

With reference to FIGS. 9 and 10, a power tool 10 configured as a detail sander 200 with a detail sander tool attachment 202 that includes horizontally reciprocating mechanical drive train 204. The motor 32 couples via drive shaft 129 to a vertically-oriented first beveled gear 206 that meshes with a horizontally-oriented second beveled gear 208 supported from above by a shaft 210 to a bearing block 212. A pin 214 on a lower face 216 of the second beveled gear 208 acts as a cam within a longitudinally oriented slot 218 in a driver block 220.

As the second beveled gear 208 rotates horizontally, the pin 214 moves the driver block 220 laterally. A wedge shaped plate 222 attached to the driver block 222 has a bottom surface 224 that accepts adhesive-backed detail sanding pads 226.

Rotary tool attachment

With reference to FIG. 11, a power tool 10 configured as a biscuit jointer 230 with a biscuit jointer tool attachment 232 having a rotary mechanical drive train 234. The motor 32 is coupled view the drive shaft 129 to a vertical beveled gear 236 that is meshed to a horizontal beveled gear 238. The horizontal beveled gear 238 is attached to a vertical shaft 240 supported by bearing blocks 242, 244. At the bottom of the shaft 240, a biscuit cutter 246 is enclosed within a housing 248 that positions the cutter 246 with respect to a workpiece. Typically, the housing 248 is adjustable to three settings for different depths of biscuit slots.

The biscuit jointer tool attachment 232 may advantageously include features to adjust the vertical centering of the cut. For example, a clear plastic plate (not shown) attached to the front of the housing 248 is vertically adjustable and configured to rest on the workpiece with a measurement guide referenced to the distance from the top of the workpiece to the cutter 246.

By appropriately selecting the relative sizes of the gears 236, 238, and altering the housing or removing the housing 248, the rotary mechanical drive train 234 may used in other types of tool attachments 14. For example, the tool attachment 14 may be configured as a drill, a hammer drill, a router, or a buffer.

Attachment Interface

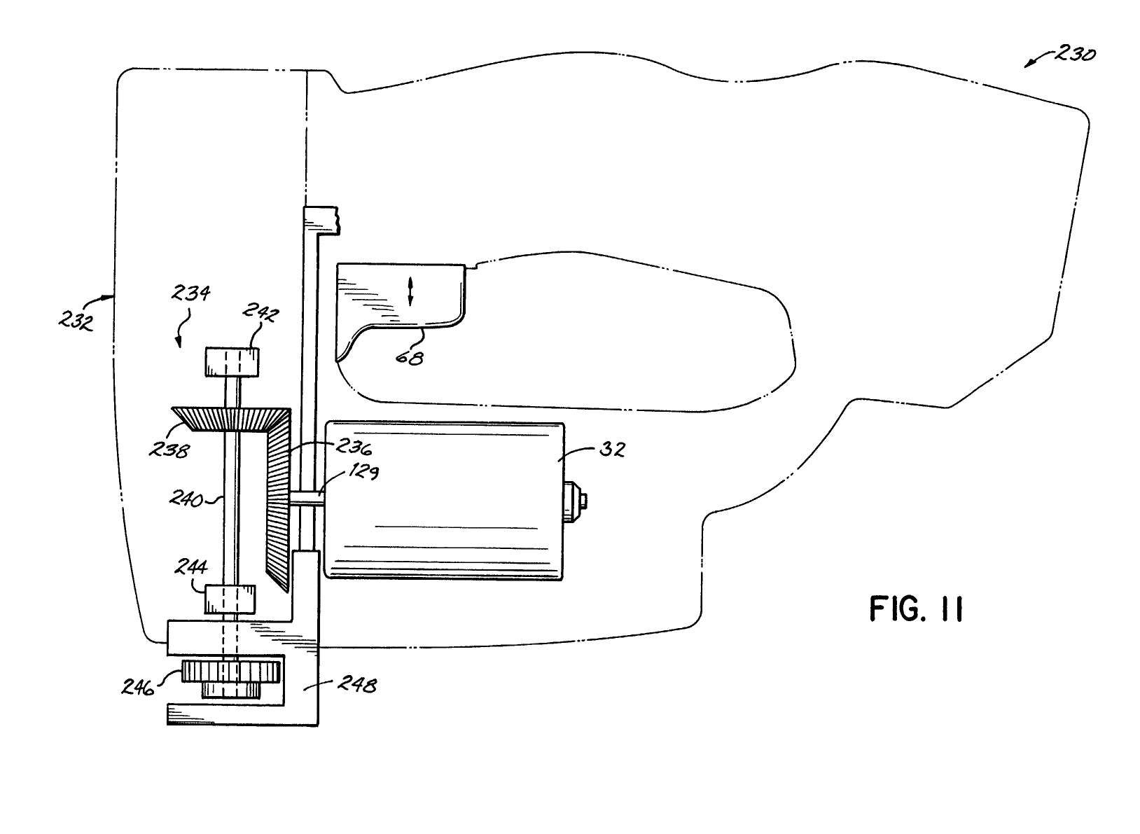

With reference to FIGS. 12A-12C, an attachment interface 24 illustrates advantages of various types of communication between the tool attachment 14 and the base unit 12. In particular, the attachment interface 24 may comprise one or more of a mechanical interface 250, an electrical interface 252 and a magnetic interface 254.

With reference to FIG. 12A, the mechanical interface 250, is formed by a coded surface portion 256 on a mating surface 258 of the tool attachment 14 contacting a coded surface detector 262 on a mating surface 264 of the base unit 12. The mechanical interface 250 performs as the attachment type designator 22 by having a plurality of microswitches 266a-266f of the coded surface detector 262 detect the presence or absence of projections 268 in the coded surface portion 256. The microswitches 266a-266f communicate with the controller 66 to indicate the presence and type of tool attachment 14.

It should be appreciated that various patterns, number and shape of projections 268 may be used. Alternatively recesses in the mating surface 258 of the tool attachment 14 may be used rather than projections 268. The shapes of the coded surface portion 256 and the code surface detector 262 may advantageously be selected to protect the microswitches 266a-266f from inadvertent contact, to assist in aligning the tool attachment 14 to the base unit 12, and for ease of manufacturing and maintenance.

With reference to FIG. 12B, the electrical interface 252 is formed by a female electrical connector 270 in the mating surface 264 of the base unit 12 that couples to a male electrical connector 272 in the mating surface 258 of the tool attachment 14. Pins 274, 276 in the male electrical connector electrically connect with electrically powered components 26 and attachment feedback sensors 27 in the tool attachment 14, respectively. The electrical interface 252 also performs as the attachment type designator 22. Specifically, a socket 278 in the female electrical connector 272 detects an omitted pin and a socket 280 in the female electrical connector 272 detects a shorted pin 282.

It should be appreciated that various types of electrical interface 252 may be selected. In addition, the electrical interface 252 may function only for communicating with electrically powered components 26 and feedback sensors 27, relying upon another component to function as the attachment type designator 22. Alternatively, the electrical interface 252 may only function as the attachment type designator 22. Furthermore, the electrical interface 252 may include flat contacts that are less likely to be damaged but that do not assist in aligning the tool attachment 14.

With reference to FIG. 12C, the magnetic interface 254 is depicted performing a plurality of functions and with different types of magnetic couplings. A pair of permanent magnetic switches 284, 286 in a magnetic sensor 288 in the base unit 12 detect the presence or absence of a corresponding permanent magnet 290 in the tool attachment 14. Magnetic switch 284 is repelled, and thus triggered, by permanent magnet 290 whereas magnetic switch 286 is not triggered. Alternatively, an inductive magnetic switch 292 senses the presence or absence of a corresponding inductive load 294 in the tool attachment 14. Thus, the magnetic switches 284, 286, 292 may function as the attachment type indicator 22.

The magnetic interface 254 also includes a pair of magnetic couplings 296, 298 to induce a current in coils 300, 302 respectively for electrically powered components 26 and attachment feedback sensor 27.

It should be appreciated that various types and configurations of magnetic switches 284, 286, 292 and magnetic couplings 296, 298 may be used. In addition, the magnetic interface 254 may be used in conjunction with either or both of the mechanical interface 250 and electrical interface 252. For example, a durable mating surface 258 of the tool attachment 14 may comprise a mechanical interface 250 for the attachment type designator 22 along with a magnetic coupling 298 for attachment feedback sensor 27.

Operation of the multi-mode power tool

In use, a tool attachment 14 is selected, such as a staple tool attachment 122. The alignment and locking mechanism 150 engages tool attachment 122 to the base unit 12. In particular, a rearward facing splined shaft 152 attached to the tool attachment 122 is guided by grooves 158 into a forward opening receptacle 154 in the base unit 12. The forward facing beveled surface 168 of the locking pin 156 comes into contact with the splined shaft 152 and is forced backward against a spring 164 until the locking pin 156 aligns with a locking pin hole 162 in the shaft 152 and engages therein.

The user installs a charged battery pack 34 into the base unit 12, positions the power tool 10 onto a work surface and squeezes the trigger 68. The power tool control system 58 in the base unit detects the attachment type designator 22 on the tool attachment 14 in order to program execute an appropriate motor control procedure 90. The controller 60 determines the appropriate motor speed setting based on motor feedback 64 and on attachment feedback 27, such as the position sensor 28 and magazine sensor 30. The controller 60 continues adjusting operation of the motor 32 based on user input 62, motor feedback 64, and attachment feedback 27.

By virtue of the foregoing, there is thus provided a power tool that is responsive to the type of engaged tool attachment by appropriately altering operation of a motor. Thus, appropriate safety and operational features are provided automatically.

While the present invention has been illustrated by the description of embodiments thereof, and while the embodiments have been described in considerable detail, it is not intended to restrict or in any way limit the scope of the appended claims to such detail. Additional advantages and modifications will readily appear to those skilled in the art.

The invention in its broader aspects is, therefore, not limited to the specific details, representative apparatus and method, and illustrative examples shown and described. Accordingly, departures may be made from such details without departing from the spirit or scope of the general inventive concept.

Having described the invention, what is claimed is:

1. A device, comprising:
a tool attachment actuated by a rotary input and including an attachment type designator; and
a base unit selectively engaged to the tool attachment, the base unit comprising:
a motor for providing the rotary input to the tool attachment; and
a motor controller responsive to a user input and to the attachment type designator of the tool attachment to selectively activate the motor.

2. The device of claim 1, wherein the tool attachment further comprises circuitry producing an attachment feedback signal, the motor controller of the base unit further responsive to the attachment feedback signal to selectively activate the motor.

3. The device of claim 2, wherein the circuitry producing the attachment feedback signal comprises a position sensor.

4. The device of claim 1, wherein the tool attachment comprises a mechanical system to convert the rotary input from the motor to a selected one of a linear reciprocating motion, a rotary motion, and a multiple impact motion.

5. The device of claim 1, wherein the tool attachment comprises a mechanical system performing multiple impact motion and includes a magazine configured to hold fasteners.

6. The device of claim 5, wherein the tool attachment further comprises a magazine sensor, the motor controller of the base unit further responsive to an electrical signal from the magazine sensor to selectively activate the motor.

7. The device of claim 1, wherein the motor is operable at a plurality of motor speeds, the motor controller responsive to the attachment type designator to selectively adjust the motor speed.

8. The device of claim 7, wherein the user input comprises a variable position trigger, the motor controller further responsive to the variable position trigger to selectively adjust the motor speed.

9. The device of claim 8, further including a manual speed adjust member, the motor controller further responsive to the manual speed adjust member to selectively adjust the motor speed.

10. The device of claim 7, wherein the base unit further comprises circuitry providing a motor feedback signal, the motor controller further responsive to the motor feedback signal to selectively adjust the motor speed.

11. The device of claim 1, further comprising a power source operable to power the motor controller and the motor.

12. The device of claim 11, further including a power source sensor operable to sense an electrical parameter of the power source, the motor controller further responsive to an electrical signal from the power source sensor to selectively activate the motor.

13. The device of claim 11, wherein the power source is configured to receive a battery and an alternating current electrical connection, the power source sensor operable to sense the presence of alternating current at the alternating current electrical current, the motor controller further responsive to an electrical signal from the power source sensor to select one of the battery and the alternating current electrical connection.

14. A portable hand tool, comprising:
a tool attachment including an attachment type designator and configured to convert a rotary input to a predetermined one of a linearly reciprocating motion, rotary motion, and multiple impact motion;
a base unit selectively engaged to the tool attachment, the base unit comprising:
a variable speed motor for providing the rotary input to the tool attachment;
a motor speed sensor operable to sense a motor speed of the variable speed motor; and
a motor controller responsive to a user input, motor speed sensor, and to the attachment type designator of the tool attachment to selectively activate the motor; and
a portable power source selectively engaged to the base unit and operable to power the variable speed motor and the motor controller.

15. A tool attachment, comprising:
a mating surface configured for attachment to a base unit;
an attachment type designator proximate to the mating surface indicating one of a plurality of attachment types to said base unit; and
a mechanical system configured to convert a rotary input from said base unit to a selected one of a linear reciprocating motion, a rotary motion, and a multiple impact motion.

16. The device of claim 15, further comprises circuitry producing an attachment feedback signal for said base unit to adjust said rotary input.

17. The device of claim 16, wherein the circuitry producing the attachment feedback signal comprises a position sensor.

18. The device of claim 15, wherein the mechanical system performs multiple impact motion, the tool attachment further comprises a magazine configured to hold fasteners.

19. The device of claim 18, wherein the tool attachment further comprises a magazine sensor for said base unit to selectively activate said rotary input.

20. The tool attachment of claim 15, wherein the attachment type designator comprises a selected one of a group consisting of a mechanical interface, an electrical interface, and a magnetic interface.

21. The tool attachment of claim 20, wherein the attachment type designator comprises the mechanical interface including a coded surface portion having selectively chosen projections.

22. The tool attachment of claim 20, wherein the attachment type designator comprises the electrical interface including a selected one of a electrical pin connector and a female electrical socket connector.

23. The tool attachment of claim 20, wherein the attachment type designator comprises the magnetic interface including a selected one of a permanent magnet target and an inductive coil target.
